(19) United States
(12) Patent Application Publication
(10) Pub. No.: US 2007/0055708 A1
(43) Pub. Date: Mar. 8, 2007

(54) Processing formulae in rules for profitability calculations for financial processing in a relational database management system

(75) Inventors: Paul H. Phibbs JR., Escondido, CA (US); Thomas K. Ryan, Valley Center, CA (US)

Correspondence Address: JAMES M. STOVER;NCR CORPORATION, 1700 SOUTH PATTERSON BLVD, WHQ4, DAYTON, OH, 45479, US

(73) Assignee: NCR Corporation

(21) Appl. No.: 11/251,667

(22) Filed: Oct. 17, 2005

Related U.S. Application Data
(60) Provisional application No. 60/714,648, filed on Sep. 7, 2005.

(51) Int. Cl. G06F 17/30

(52) U.S. Cl. 707/201

(57) ABSTRACT

A Value Analyzer system is a data-driven computer-facilitated financial model that provides accurate and consistent profitability calculations using account, product and event attributes stored in a relational database managed by a relational database management system (RDBMS). Profitability calculations are performed in the computer by applying one or more rules to the account, product and event attributes accessed from the database, wherein at least one of the rules contains one or more formulae that is reconstructed and dynamically interpreted when the rule is being performed.

### CROSS REFERENCE TO RELATED APPLICATIONS

This application claims priority under 35 U.S.C §119(e) to co-pending and commonly-assigned Provisional Application Ser. No. 60/714,648, filed on Sep. 7, 2005, by Paul R Phibbs, Jr. and Thomas K. Ryan, entitled “PROCESSING FORMULAE IN RULES FOR PROFITABILITY CALCULATIONS FOR FINANCIAL PROCESSING IN A RELATIONAL DATABASE MANAGEMENT SYSTEM,” attorney's docket number 12044, which application is incorporated by reference herein.

This application is related to the following co-pending and commonly assigned patent applications:

Utility application Ser. No. 10/227,909, filed on Aug. 26, 2002, by Brian J. Wasserman and Thomas K. Ryan, entitled “PLATFORM INDEPENDENT ARCHITECIURE FOR FINANCIAL PROCESSING IN A RELATIONAL DATABASE MANAGEMENT SYSTEM,” attorneys' docket number 9888;

Utility application Ser. No. 10/227,783, filed on Aug. 26, 2002, by George R. Hood, Brian J. Wasserman, Thomas K. Ryan and Sang Y. Yum, entitled “SELECTION PROCESSING FOR FINANCIAL PROCESSING IN A RELATIONAL DATABASE MANAGEMENT SYSTEM” attorneys' docket number 10434;

Utility application Ser. No. 10/227,726, filed on Aug. 26, 2002, by Richard C. Schwarz, Brian J. Wasserman, Sang Y. Yum and Thomas K. Ryan, entitled “DRIVER AMOUNT/COUNT SELECTION FOR FINANCIAL PROCESSING IN A RELATIONAL DATABASE MANAGEMENT SYSTEM,” attorneys' docket number 10435;

Utility application Ser. No. 10/227,976, filed on Aug. 26, 2002, by Brian J. Wasserman, George R Hood and Thomas K. Ryan, entitled “DISCRETE PROFITABILITY CALCULATIONS FOR FINANCIAL PROCESSING IN A RELATIONAL DATABASE MANAGEMENT SYSTEM” attorneys' docket number 10443;

Utility application Ser. No. 10/228,022, filed on Aug. 26, 2002, by Brian J. Wasserman, George R Hood and Thomas K. Ryan, entitled “RULES-BASED, DATA-DRIVEN PROFITABILITY CALCULATIONS FOR FINANCIAL PROCESSING IN A RELATIONAL DATABASE MANAGEMENT SYSTEM,” attorneys' docket number 10444;

Utility application Ser. No. 10/228,031, filed on Aug. 26, 2002, by Brian J. Wasserman, entitled “OBJECT-ORIENTED REPRESENTATION OF A GENERIC PROFITABILITY RULE FOR FINANCIAL PROCESSING IN A RELATIONAL DATABASE MANAGEMENT SYSTEM,” attorneys' docket number 10440;

Utility application Ser. No. 10/016,779, filed on Dec. 10, 2001, by Brian J. Wasserman, entitled “PARALLEL SELECTION PROCESSING FOR FINANCIAL PROCESSING IN A RELATIONAL DATABASE MANAGEMENT SYSTEM,” attorneys' docket number 9620;

Utility application Ser. No. 10/013,422, filed on Dec. 10, 2001, by Brian J. Wasserman, entitled “ACCOUNT SELECTION FOR FINANCIAL PROCESSING IN A RELATIONAL DATABASE MANAGEMENT SYSTEM,” attorneys' docket number 9621;

Utility application Ser. No. 10/013,434, filed on Dec. 10, 2001, by Brian J. Wasserman, entitled “DRIVER AMOUNT AND COUNT SELECTION PROCESSING FOR FINANCIAL PROCESSING IN A RELATIONAL DATABASE MANAGEMENT SYSTEM,” attorneys' docket number 9675;

Utility application Ser. No. 10/016,452, filed on Dec. 10, 2001, by Brian J. Wasserman, George R Hood, and Thomas K. Ryan, entitled “DYNAMIC EVENT SELECTION FOR FINANCIAL PROCESSING IN A RELATIONAL DATABASE MANAGEMENT SYSTEM” attorneys' docket number 9618;

Utility application Ser. No. 09/943,060, filed on Aug. 30, 2001, by Paul H. Phibbs, Jr., entitled “CAPITAL ALLOCATION IN A NET INTEREST REVENUE IMPLEMENTATION FOR FINANCIAL PROCESSING IN A RELATIONAL DATABASE MANAGEMENT SYSTEM,” attorneys' docket number 9391;

Utility application Ser. No. 09/943,059, filed on Aug. 30, 2001, by Paul H. Phibbs, Jr., entitled “ALLOCATED BALANCES IN A NET INTEREST REVENUE IMPLEMENTATION FOR FINANCIAL PROCESSING IN A RELATIONAL DATABASE MANAGEMENT SYSTEM,” attorneys' docket number 9512;

Utility application Ser. No. 09/845,461, filed on Apr. 30, 2001, by George R. Hood, entitled “TAX ADJUSTMENT FOR FINANCIAL PROCESSING IN A RELATIONAL DATABASE MANAGEMENT SYSTEM,” attorneys' docket number 9522;

Utility application Ser. No. 09/845,924, filed on Apr. 30, 2001, by George R. Hood, entitled “AMORTIZATION FOR FINANCIAL PROCESSING IN A RELATIONAL DATABASE MANAGEMENT SYSTEM,” attorneys' docket number 9435;

Utility application Ser. No. 09/845,851, filed on Apr. 30, 2001, by George R. Hood, entitled “SHAREHOLDER VALUE ADD FOR FINANCIAL PROCESSING IN A RELATIONAL DATABASE MANAGEMENT SYSTEM,” attorneys' docket number 9511;

Utility application Ser. No. 09/608,355, filed on Jun. 29, 2000, by George R. Hood and Paul H Phibbs, Jr., entitled “ADVANCED AND BREAKTHROUGH NET INTEREST REVENUE IMPLEMENTATION FOR FINANCIAL PROCESSING IN A RELATIONAL DATABASE MANAGEMENT SYSTEM,” attorneys' docket number 9006;

Utility application Ser. No. 09/610,646, filed on Jun. 29, 2000, by George R. Hood and Paul H Phibbs, Jr., entitled “BASIC AND INTERMEDIATE NET INTEREST REVENUE IMPLEMENTATION FOR FINANCIAL PROCESSING IN A RELATIONAL DATABASE MANAGEMENT SYSTEM,” attorneys' docket number 8980;

Utility application Ser. No. 09/608,681, filed on Jun. 29, 2000, by George R. Hood, entitled “OTHER REVENUE IMPLEMENTATION FOR FINANCIAL PROCESSING IN A RELATIONAL DATABASE MANAGEMENT SYSTEM,” attorneys' docket number 9015;

Utility application Ser. No. 09/608,675, filed on Jun. 29, 2000, by George R. Hood, entitled “DIRECT EXPENSE IMPLEMENTATION FOR FINANCIAL PROCESSING IN A RELATIONAL DATABASE MANAGEMENT SYSTEM,” attorneys' docket number 9010;

Utility application Ser. No. 09/608,342, filed on Jun. 29, 2000, by George R. Hood, entitled “INDIRECT EXPENSE IMPLEMENTATION FOR FINANCIAL PROCESSING IN A RELATIONAL DATABASE MANAGEMENT SYSTEM,” attorneys' docket number 9008; and

Utility application Ser. No. 09/608,682, filed on Jun. 29, 2000, by George R. Hood, entitled “RISK PROVISION IMPLEMENTATION FOR FINANCIAL PROCESSING IN A RELATIONAL DATABASE MANAGEMENT SYSTEM,” attorneys' docket number 9011;

all of which applications are incorporated by reference herein.

### BACKGROUND OF THE INVENTION

1. Field of the Invention

This invention relates in general to financial processing systems performed by computers, and in particular, to the processing of formulae in rules for profitability calculations for financial processing using data accessed from a relational database management system.

2. Description of Related Art

Financial processing systems provide tools for financial analysis of accounting data. Typically, each financial processing system operates in a unique way and approaches financial analysis differently. Some financial processing systems are advanced in their approach to profitability calculations, and others are still at a more basic level. In addition, there is no agreement as to the rules for profitability calculations, outside of generally accepted accounting policies that external auditors use.

Yet, the majority of financial processing systems are inefficient in their accessing of relational databases. There is a need, then, for an improved approach for performing financial processing from a relational database, especially in the area of rules for profitability calculations.

### SUMMARY OF THE INVENTION

A Value Analyzer system is a data-driven computer-facilitated financial model that provides accurate and consistent profitability calculations using account, product and event attributes stored in a relational database managed by a relational database management system (RDBMS).

The present invention performs financial processing in a computer by: (a) accessing account, product and event attributes from a database, wherein: (1) the account attributes comprise data about accounts being measured, (2) the product attributes comprise data about products being purchased, and (3) the event attributes comprise data about account-related and product-related transactions; (b) performing one or more profitability calculations by applying one or more rules to the account, product and event attributes accessed from the database; and (c) wherein at least one of the rules contains one or more formulae that is reconstructed and dynamically interpreted when the rule is being performed.

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention;

FIG. 2 is a data flow diagram that illustrates the operation of the Value Analyzer according to the preferred embodiment of the present invention;

FIG. 3 illustrates a representation of profitability rules in a Value Analyzer system according to the preferred embodiment of the present invention;

FIG. 4 illustrates a representation of equations in profitability rules in a Value Analyzer system according to the preferred embodiment of the present invention; and

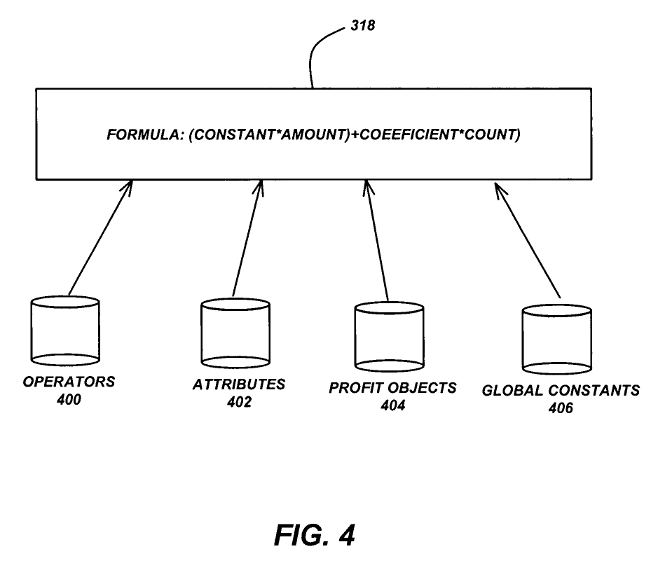

FIG. 5 is a flow chart illustrating the logic of the preferred embodiment of the present invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Overview

A Value Analyzer system is a data-driven computer-facilitated financial model that provides accurate and consistent profitability calculations using account, product and event attributes stored in a relational database managed by a relational database management system (RDBMS).

### Hardware and Software Environment

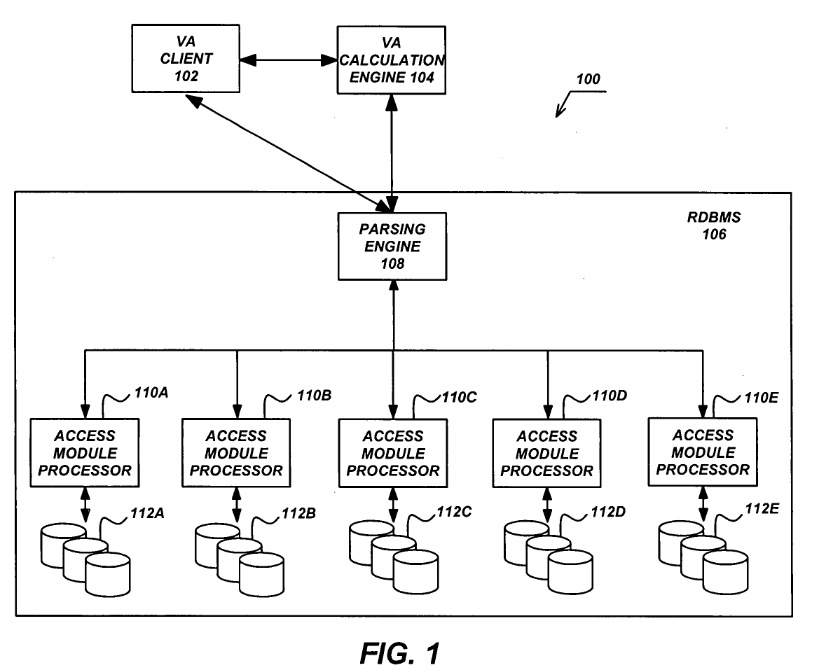

FIG. 1 illustrates an exemplary hardware and software environment according to the preferred embodiment of the present invention. In the exemplary environment, a computer system 100 implements a financial processing system, known as the Value Analyzer system, in a three-tier client-server architecture, wherein the first or client tier provides a Value Analyzer Client 102 that may include, inter alia, a graphical user interface (GUI), the second or middle tier provides a Value Analyzer Calculation Engine 104 for performing functions as described later in this application, and the third or server tier comprises a Relational Data Base Management System (RDBMS) 106 that stores data and metadata in a relational database. The first, second, and third tiers may be implemented in separate machines, or may be implemented as separate or related processes in a single machine.

In the preferred embodiment, the RDBMS 106 includes at least one Parsing Engine (PE) 108 and one or more Access Module Processors (AMPs) 110A-110E storing the relational database in one or more data storage devices 112A-112E. The Parsing Engine 108 and Access Module Processors 110 may be implemented in separate machines, or may be implemented as separate or related processes in a single machine. The RDBMS 106 used in the preferred embodiment comprises the Teradata® RDBMS sold by NCR Corporation, the assignee of the present invention, although other DBMS's could be used.

Generally, the Value Analyzer Client 102 includes a graphical user interface (GUI) for operators of the system 100, wherein requests are transmitted to the Value Analyzer Calculation Engine 104 and/or the RDBMS 106, and responses are received therefrom. In response to the requests, the Value Analyzer Calculation Engine 104 performs the functions described below, including formulating queries for the RDBMS 106 and processing data retrieved from the RDBMS 106. Moreover, the results from the functions performed by the Value Analyzer Calculation Engine 104 may be provided directly to the Value Analyzer Client 102 or may be provided to the RDBMS 106 for storing into the relational database. Once stored in the relational database, the results from the functions performed by the Value Analyzer Calculation Engine 104 may be independently retrieved from the RDBMS 106 by the Value Analyzer Client 102.

Note that the Value Analyzer Client 102, the Value Analyzer Calculation Engine 104, and the RDBMS 106 may be implemented in separate machines, or may be implemented as separate or related processes in a single machine. Moreover, in the preferred embodiment, the system 100 may use any number of different parallelism mechanisms to take advantage of the parallelism offered by the multiple tier architecture, the client-server structure of the Value Analyzer Client 102, Value Analyzer Calculation Engine 104, and RDBMS 106, and the multiple Access Module Processors 110 of the RDBMS 106. Further, data within the relational database may be partitioned across multiple data storage devices 112 to provide additional parallelism.

Generally, the Value Analyzer Client 102, Value Analyzer Calculation Engine 104, RDBMS 106, Parsing Engine 108, and/or Access Module Processors 110A-110E comprise logic and/or data tangibly embodied in and/or accessible from a device, media, carrier, or signal, such as RAM, ROM, one or more of the data storage devices 112A-112E, and/or a remote system or device communicating with the computer system 100 via one or more data communications devices.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

### Value Analyzer Operation

The Value Analyzer system is a data-driven computer-facilitated financial model that provides accurate and consistent profitability calculations using account, event and Product data stored in the RDBMS 106, wherein: (1) the account attributes comprise data about accounts being measured, (2) the event attributes comprise data about account-related transactions, and (3) product attributes comprise data about products being purchased. The profitability calculations performed by the Value Analyzer system rely on a Five Factor Atomic Profit Metric (FFAPM):

$$\begin{matrix}Profit = Net Interest Revenue ( NIR ) \\ + Other Revenue ( OR ) \\ - Direct Expense ( DE ) \\ - Indirect Expense ( IE ) \\ - Risk Provision ( RP ) \\ = NIR + OR - DE - IE - RP\end{matrix}$$

In the above equation, it is assumed that the sign of elements that reduce profit are negative and those that contribute are positive.

Each of the five factors of FFAPM are defined below.
Net Interest Revenue. This component comprises interest revenue, and is the largest component of profitability (e.g., from loans, deposits, cash, etc.).
Other Revenue. This component comprises non-interest revenue (e.g., fees and commissions), including those driven by events (e.g., open account, excessive counter withdrawals, early payout penalties, etc.).
Direct Expense. This component comprises expenses driven by events that are attributable to accounts.
Indirect Expense. This component comprises expenses that are not attributable to specific accounts. This includes expenses that relate to the cost of doing business that are not driven by account or event activity, such as those that arise from overheads, inefficiencies or differences between standard and actual costs (e.g., the CEO's salary, etc.).
Risk Provision. This component comprises the expected cost of risks that arise from the uncertainties of doing business, e.g., market risks, customer credit, competition, operations, regulatory risks, political risks, etc.

Each of these five factors can be measured for a desired period (daily, weekly, monthly, quarterly, etc.). Moreover, each factor is essentially discrete and independent with fundamentally different characteristics, which strengthens the user's ability to fully utilize the output to determine relationships between account, event and Product data, and enable consistent multiple dimensional aggregation.

The FFAPM is “atomic” in that profitability is computed using data stored in the RDBME 106. There are three aspects to this:
components of profitability may be measured below the account level (at events which make up account activity over an accounting period) and accumulated to the account,
components of profitability may be measured directly at the account level (such as interest paid or earned for an accounting period),
components of profitability may be known, obtained, or aggregated at a higher level, and may be apportioned down to specific accounts and events according to various rules.

The Value Analyzer generally defines “indirect” components of profitability to be those which must be apportioned to accounts and “direct” components to be those which are either computed at the account level, or are rolled up to the account level from lower level events.

### Value Analyzer Data Flow

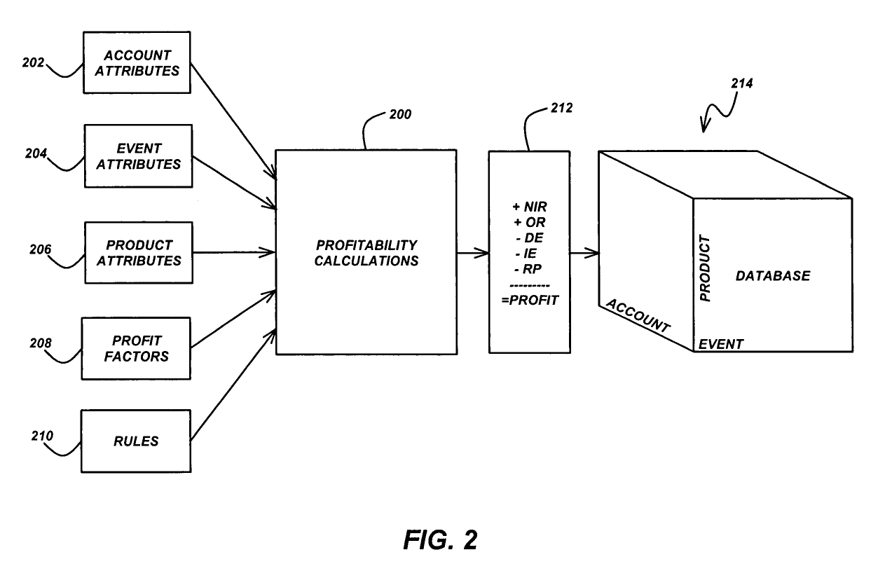

FIG. 2 is a data flow diagram that illustrates the operation of the Value Analyzer system according to the preferred embodiment of the present invention. Within the Value Analyzer Calculation Engine 104, one or more Profitability Calculations 200 accept a number of inputs including Account Attributes 202, Event Attributes 204, Product Attributes 206, and Profit Factors 208. Thereafter, the Profitability Calculations 200 invoke one or more Rules 210 that generate the FFAPM 212, which in turn are used to create the Database 214. The Database 214 may be represented along account, event, or product dimensions, or along other dimensions as may be required. These elements are described in more detail below.

Input Definitions

Account Attributes 202 comprise data about the accounts being measured. This data includes: balance, rate (or interest accrued), product identification, limits, expected default frequency, and various dates (e.g., open, rate reset, last payment, next payment, maturity, etc.).

Event Attributes 204 comprise data about account-related events or transactions. This data includes: account identification, event or transaction amounts, event or transaction location, event or transaction time, counter-party identification, event or transaction type (e.g., loan payment, interest paid, loan draw down amount, etc.).

Product Attributes 206 comprise data about products being purchased. This data includes product identification, unit price amounts, etc.

Profit Factors 208 include parameter values necessary to perform the Profitability Calculations 200. The major classifications of this data include:
Funds transfer rates are pricing methods that require matched maturity opportunity rates for use in valuing each account's marginal use or source of internal funds.
Unit costs are used for Direct Expense calculations, where a total cost is provided as an Product Attribute 206 and the Unit Cost is then derived by dividing total cost by actual volume. Unit Costs can be either standard, actual, or market, and ideally represent marginal values (if “fully absorbed measures” are used, then the usefulness of allocated amounts is diminished.)
Allocated amounts are used in both Other Revenue and Indirect Expense calculations, wherein the allocated amounts are apportioned amongst all accounts in a group.
Miscellaneous calculation values may comprise, for example, the number of days in a profit measurement period, an equity allocation weighting, etc. These values are known as “modeling” parameters.
Amortization parameters are used in interest amortization, which requires interest rates and life values used by straight-line amortization and by declining balance of amortization.
Risk measurement parameters are used in Risk Provision calculations, which require various factors, such as: loss rates, reserve percentages, exposure factors, recovery rates, default probabilities and collection costs.
Tax rates are required for after-tax profit calculation. The Value Analyzer is designed to calculate pre-tax income on a taxable equivalent basis (where an effective tax rate is all that is required to transform pre-tax income into after tax earnings, i.e., Profit).

Rules

The Profitability Calculations 200 use one or more Rules 210 applied to data retrieved from the RDBMS 106. These Rules 210 include, inter alia, the following:

Treatments. Every account with cash flows affecting a organization's balance sheet requires a method of valuing the account's use of internal funds. One approach is “matched maturity funds transfer pricing,” which uses a canonical representation of an account's funding characteristics and then determines a value based on adjusted market yields for each instance that requires an interest rate transfer price to calculate an account's marginal Net Interest Revenue.

Equity Allocation. In order to provide precise Net Interest Revenue calculations, the amount of equity funds required at an account must be determined. This rule allows for equity allocation using any of the following methods: simple ratios; regulatory definitions; economic allocations, or user defined allocations.

Apportionment. Other Revenue, Risk Provision and Indirect Expense calculations are applied at the account level using Product Attributes 206 that are not related directly to account activity. These profit adjustments are made so that the sum of all account-level Profitability Calculations 200 comprises the overall profit. One approach is to pool indirect costs and revenues and then apportion them. Apportionment rules specify how the pooled indirect costs and revenues is completely allocated to appropriate accounts, wherein the preferred embodiment uses closed form allocation rules, which require only information known in the current period and not iterative computation.

Amortization. Some types of income or expense are deferred or accrued over multiple periods, including and subsequent to the current accounting period. This is common to accrual accounting methods used in profit presentations of financial statements, and gives rise to timing differences between cash flows and their related profit as presented in a financial statement in any accounting period. Since the Value Analyzer system is designed to reconcile to the financial statement's profit values, it supports deferral and accrual accounting principles. Amortization methods that account for these timing differences are: interest amortization (used for interest income and expense accruals and for deferral of fees that are in lieu of interest), and straight line or declining balance amortizations (used for cost deferrals and investment depreciation).

Other Revenue Pricing. In situations where account and event activity can be used to derive account level income or fees, the Value Analyzer system calculates these drivers of the profitability in the Other Revenue calculations. These calculations comprise linear combinations of event or account values and modeled coefficients.

Direct Expense. The calculation of account profit adjustments due to account-related activity requires rules that take the form of linear combinations of event or account values and modeled coefficients.

Indirect Expense. In situations where expense apportionment or amortization amounts are aggregated, the user may want different rules applied depending on the path (or dimension) of aggregation. These rules allow for multiple Profitability Calculations rules to be applied to derive multiple account level Indirect Expense amounts.

Risk Provision. Adjusting current profit for expected future losses is known as “actuarial” profit provisioning. The Value Analyzer system applies actuarial-based methods in its account level Profitability Calculations, where the actuarial reserve that the provisions maintain represents the expected loss associated with all accounts.

Taxable Equivalent Gross-up. Profit is an after-tax measure, and thus some events or portions of some accounts' profits may be excluded from normal taxation. The Value Analyzer system adjusts these pre-tax values, so that a singular tax rate can be used to convert pre-tax profit into after-tax values, which are also known as taxable equivalent adjustment. These rules use account and event attributes to adjust each of the five factors of the FFAPM to a taxable equivalent basis.

Interest Yield Adjustments. Since the Value Analyzer system can calculate profits for any number of periods, the adjustment of cash interest payments, and the financial statement's accrual or smoothed representation of interest-related Profit, the Value Analyzer system provides a method for converting cash interest amounts to accrual amounts for financial statements. The Value Analyzer system implements an “effective interest rate” conversion to accomplish this type of calculation.

Profitability Calculations

The following describes the method used by the Profitability Calculations 200:
1. Retrieve data from the RDBMS 106.
2. Calculate Net Interest Revenue for every account.
3. Calculate Other Revenue for every account.
4. Calculate Direct Expense for every account.
5. Calculate Indirect Expense for every account.
6. Calculate Risk Provision for every account.
7. Calculate Profit for every account.
8. Store the FFAPM Profit and the five factors of FFAPM into the RDBMS 106.
9. Aggregate and/or re-calculate the FFAPM Profit and the five factors of FFAPM as necessary.

Note that steps 2 through 6 perform account-level calculations. Steps 2, 3, 4, 5, and 6 can be performed independently and in parallel, while step 7 requires values derived in steps 2, 3, 4, 5, and 6, and therefore must be performed after steps 2, 3, 4, 5, and 6 are completed.

Output Definition

The Profitability Calculations 200 generate one or more values for the five factors of the FFAPM 212, and specifically, the NIR, OR, DE, IE, RP, and Profit values. These values are used to generate the Database 214, which comprises one or more tables stored by the RDBMS 106 in the relational database.

### Rules and Equations in Profitability Calculations

In the Value Analyzer system, there are many types of Rules 210 used in the Profitability Calculations 200, such as Risk Provision (RP) Rules, Net Interest Revenue (NIR) Rules, Direct Expense (DE) Rules, Indirect Expense (IE) Rules, and Other Revenue (OR) Rules, as well as different levels (Basic, Intermediate, Advanced, Breakthrough) for each type of Rule 210.

Generic Profitability Rule

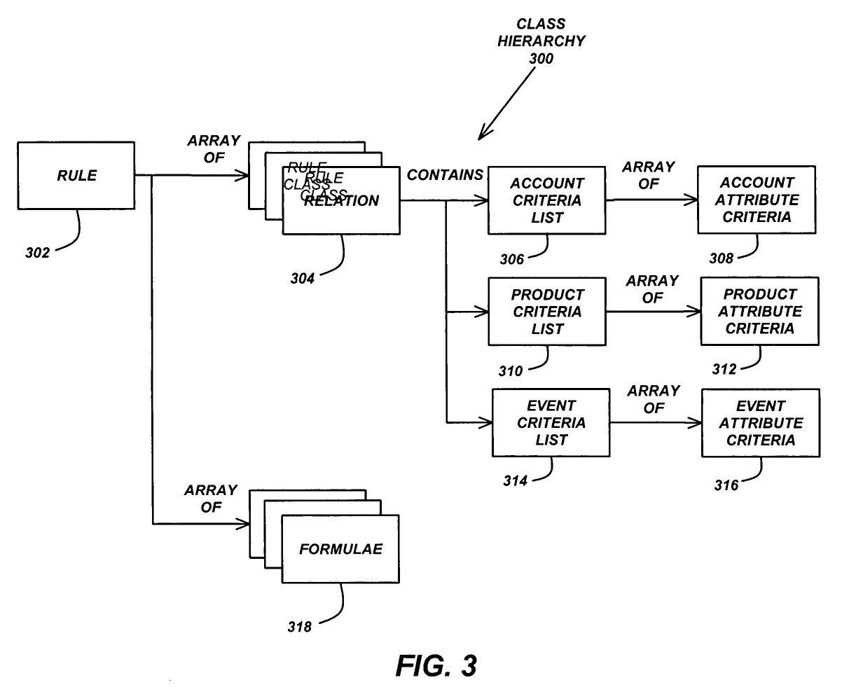

FIG. 3 illustrates a class hierarchy 300 used to represent the Rules 210 according to the preferred embodiment of the present invention. The class hierarchy 300 is comprised of one or more objects, including a root node object 300 representing the Rule 210. Each Rule 210 is comprised of an array of one or more Relations 304. Each Relation 304 may include an Account Criteria List 306 (which is an array of Account Attribute Citeria 308), a Product Citeria List 310 (which is an array of Product Attribute Criteria 312), and an Event Criteria List 314 (which is an array of Event Attribute Criteria 316).

The Value Analyzer Client 102 has the ability to display the entire hierarchy 300, as well as groups of objects or individual objects. Dialogs are provided that allow the users to display, add, modify, and delete Rules 210, Relations 304, Criteria Lists 306, 310 and 314 and Criteria 308, 312 and 316, as needed. Corresponding tables in the RDBMS 106 are updated as appropriate.

While not all types or levels of Rules 210 allow for all types of criteria 308, 312 and 316, including them all in the hierarchy 300 provides for a single, extensible base class specification. On the other hand, each type or level of Rules 210 will use at least one of the types of criteria 308, 312, 316.

For example, assume a Rule 210 includes the following Relations 304:
PRODUCT IN (PROD1, PROD2) AND STATUS=OPEN
OR
PRODUCT=PROD3 AND TERM>30 AND STATUS=OPEN

In this example, “PRODUCT IN (PROD1, PROD2) AND STATUS=OPEN” is identified as Relation #1, and “PRODUCT=PROD3 AND TERM>30 AND STATUS=OPEN” is identified as Relation # 2.

Relation # 1 contains one Account Attribute Criteria 308 and two Product Attribute Criteria 312, which are joined together and evaluated with an AND operator:
Account Attribute Criteria: STATUS=OPEN
AND
Product Attribute Citeria: PRODUC™ IN (PROD1, PROD2)

Relation # 2 contains two Account Attribute Criteria 308 and one Product Attribute Criteria 312, which are joined together and evaluated with an AND operator:
Account Attribute Criteria: STATUS=OPEN
AND
Account Attribute Criteria: TERM>30
AND
Product Attribute Criteria: PRODUCT=PROD3

Formula Used in Rules

At least one of the Rules 210 may also contain one or more Formulae 318 or equations that can be used in the Profitability Calculations 200 and that is reconstructed and dynamically interpreted when the Rule 210 is being performed. A Formula 318 is comprised of component elements that are mapped from the relational database For example, the Formula 318 may be a variation of the following:
(Constant*Amount)+(Coefficient*Count)
wherein ‘(‘,’)’, ‘*’, and ‘+’ are user-defined component elements mapped or referenced from an Operator table 400 in the RDBMS 106, while Constant, Amount, Coefficient and Count are user-defined component elements mapped or referenced from an Attribute table 402, Profit Object from a Previous Rule (i.e., previous Rule 210 results) table 404, or Global Constant table 406 in the RDBMS 106.

A Formula 318 may be created using the Value Analyzer Client 102, and then stored in a Rules Table (not shown) in the RDBMS 106. Thereafter, the Formula 318 is dynamically interpreted by the Value Analyzer Calculation Engine 104 when the Rule 210 is being performed.

For example, in one embodiment, a Formula 318 may be stored in a column of one or more rows in a Rule Table representing the associated Rule 210. The Formula 318 is parsed into its component elements and the component elements are stored as types (that identify a table 400, 402, 404, 406 in the RDBMS 106) and ids (that identify a key into the table 400, 402, 404, 406). For example, in the Rule Table, each row stores an element as a type (Operator, Attribute, Profit Object from a previous Rule 210, or Global Constant) and an id.

The data retrieved by the foreign key from the table 400, 402, 404, 406 identifies the Operator, maps or references the Attribute, maps or references the Profit Object from the previous Rule 210, or indicates the value of the Global Constant. When the Value Analyzer Calculation Engine 104 executes a Formula 318 when performing the Rule 210, it accesses the elements in the Rule Table, as well as the corresponding rows in the tables 400, 402, 404, 406, and then reconstructs the Formula 318 using this data. The Value Analyzer Calculation Engine 104 then uses the reconstructed Formula 318 in performing the Profitability Calculations 210.

The component elements may be updated without changing the Formula 318, which allows the user to update values for the elements in the Formula 318 without having to change the Formula 318 itself.

For example, the user may define one of the elements as Global Constant comprising an interest rate value. The value for this Global Constant is stored in the Global Constant table 400, which may updated by the user. In the Rule Table, the Global Constant is stored as a form type and form id for the Rule 210 containing the Formula 318, but not the value itself. When the Formula 318 is executed, the Value Analyzer Calculation Engine 104 reconstructs the Formula 318 from the elements, and performs the necessary substitutions using the types and corresponding ids. Thus, the user can change the value of interest rate without having to change the Formula 318 itself.

Data Structures and Tables Used for Formulae

The Value Analyzer Calculation Engine 104 performs conversions to translate a Formula 318 to one or more text strings that the Engine 104 can use for SQL generation. The conversions are described in terms of the data structures or schema and tables set forth below.

The following Formula Components schema describes how the Formulae 318 are stored in the Rules Table in the RDBMS 106.

Formula Components

| Column | Description |
|---|---|
| Current Rule Id | Identifies the current Rule 210. |
| Current Formula Sequence | Uniquely identifies each row for this Rule |
| Number | 210 in order. |
| Current Formula Type | Numeric value identifying the component |
| String | as an operator, attribute, previous Rule 210 |
| | or global constant |
| Operator Id | Code if this type is an operator. |
| Attribute Column Id | Code if this type is an attribute. |
| Previous Rule Id | Code if this type is a previous rule. |
| Global Constant Id | Code if this type is a global constant. |

The Formula Components are converted into a Flexible Engine Formula Components schema for use by the Value Analyzer Calculation Engine 104.

Flexible Engine Formula Components

| Column | Description |
|---|---|
| Rule Id | The current Rule 210. |
| Formula Component | The unique sequence number. |
| Sequence Number | |
| Formula Component Type | The component type. |
| Operator Text | Text of the operator. |
| Previous Rule Id | Previous Rule 210 result to use. |
| Profit Object Type Code | Profit Object of previous Rule 210 or |
| | attribute (column). |
| View Name | Attribute (view of column to use). |
| Column Name | Attribute (column of above view to use). |
| Global Constant Id | Global Constant to use. |

The following reference tables illustrate how the conversions are performed, by mapping or referencing

Rules 210

| | |
|---|---|
| Rule ID | An identifier for the Rule 210. |
| Rule Name | A name for the Rule 210. |
| Category Amount | A category amount. |
| Account Selection Method | An account selection method. |
| Category Amount | A category account calculation method. |
| Calculation Method | |
| Component ID | An identifier for a component of the Rule |
| | 210. |
| Apportionment Method | An apportionment method. |
| Amortize Indicator | An amortization indicator. |
| Rule Query | A query object used to load and save the |
| | Rule 210 from the relational database. |
| Row ID | An identifier of a row returned by the Rule |
| | 210 Query. |

Relations 304

| | |
|---|---|
| Rule ID | An identifier for the Rule 210. |
| Relation ID | An identifier for the Relation 304. |
| Relation Name | A name for the Relation 304. |
| Relation Type | Either base or adjustment. |
| Relation Query | A query used to load and save data for the |
| | Relation 304. |
| Relation Criteria Query | A query used to load and save data for the |
| | associated Lists 306, 310 and 314. |
| Account Criteria List | The Account Criteria List 306, which |
| | comprises an array of Account Attribute |
| | Criteria 308 associated with the Relation 304. |
| Product Criteria List | The Product Criteria List 310, which |
| | comprises an array of Product Attribute |
| | Criteria 312 associated with the Relation 304. |
| Event Criteria List | The Event Criteria List 314, which |
| | comprises an array of Event Attribute |
| | Criteria 316 associated with the Relation 304. |

Operator Table 400

| Operator Id | Symbol Text | SQL Text | Description |
|---|---|---|---|
| 1 | ( | ( | Left Parenthesis |
| 2 | ) | ) | Right Parenthesis |
| 3 | + | + | Addition |
| 4 | − | − | Subtraction |
| 5 | * | * | Multiplication |
| 6 | / | / | Division |
| 7 | R-SUM | R-SUM | Related Object Sum |
| 8 | T-SUM | T-SUM | Total Object Sum |
| 9 | \hat{ } | ** | Exponentiation |
| 10 | LOG | LOG | Logarithm |
| 11 | SQRT | SQRT | Square Root |

Global Constant Table 406

| Global Constant Id | Value | Description |
|---|---|---|
| 1 | 1.0 | One |
| 2 | 100.0 | One hundred |
| 10 | 7.0 | Capital multiplier |
| 11 | 0.10 | Cost of capital rate |
| 12 | 0.05 | Risk free capital rate |
| 13 | 4.0 | Expected loss volatility |
| 14 | 0.8224 | Operating risk direct |
| | | expense rate |
| 15 | 0.3771 | Credit risk direct expense |
| | | rate |

View Definition (Attributes 402 and Profit Objects 404)

| View | Database | Profit Object | View Type | |
|---|---|---|---|---|
| Id | Id | Type Code | Code | View Name |
| 101 | 1 | 101 | 1 | CONTRACT |
| 102 | 1 | 102 | 1 | CLIENT |
| 103 | 1 | 103 | 1 | SEGMENT |
| 104 | 1 | 104 | 1 | DIVISION |
| 105 | 1 | 105 | 1 | OFFICE |
| 106 | 1 | 106 | 1 | AREA |
| 107 | 1 | 107 | 1 | ECONOMIC_SECTOR |
| 108 | 1 | 108 | 1 | PRODUCT |
| 109 | 1 | 109 | 1 | PRODUCT |
| | | | | GROUP |

Column Definition (Attributes 406 and Profit Objects 404)

| | Data | | | | |
|---|---|---|---|---|---|
| Column | Type | | | | Column Display |
| Id | Code | View Id | Table Id | Column Name | Name |
| 107 | 10 | 101 | 101 | Limit | Contract Limit |
| 108 | 10 | 101 | 101 | Balance | Contract Balance |
| 109 | 10 | 101 | 101 | Margin | Contract Margin |
| 110 | 10 | 101 | 101 | Commissions | Contract |
| | | | | | Commissions |
| 111 | 11 | 101 | 101 | Direct Cost | Contract Direct |
| | | | | | Cost |
| 112 | 11 | 101 | 101 | Indirect Cost | Contract Indirect |
| | | | | Business | Cost Business |
| 113 | 11 | 101 | 101 | Indirect Cost | Contract Indirect |
| | | | | Structure | Cost Structure |
| 114 | 11 | 101 | 101 | Collateral | Contract |
| | | | | | Collateral |
| 115 | 7 | 101 | 101 | Num Scoring | Contract Scoring |
| 116 | 7 | 101 | 101 | Cod Rating | Contract Rating |
| 117 | 12 | 101 | 101 | Exposure At | Contract |
| | | | | Default Rate | Exposure At |
| | | | | | Default |
| 118 | 12 | 101 | 101 | Loss Given | Contract Loss |
| | | | | Default Rate | Given Default |
| | | | | | Rate |
| 119 | 13 | 101 | 101 | Probability To | Contract |
| | | | | Default Rate | Probability to |
| | | | | | Default Rate |
| 120 | 14 | 101 | 101 | Correlation Rate | Contract P Cor |
| 121 | 3 | 101 | 101 | Risk Provision | Contract RP |
| | | | | Amt | |
| 122 | 10 | 101 | 101 | Total Revenue | Contract Total |
| | | | | Amt | Revenue |
| 123 | 15 | 101 | 101 | EC Internal Fraud | Contract EC |
| | | | | Rate | Internal Fraud |
| | | | | | Rate |
| 124 | 17 | 101 | 101 | EC External | Contract EC |
| | | | | Fraud Percent | External Fraud |
| | | | | | Percent |

Using these tables, a Formula 318 can be reconstructed and dynamically interpreted Value Analyzer Calculation Engine 104 when the Rule 210 is being performed.

### Logic of the Preferred Embodiment

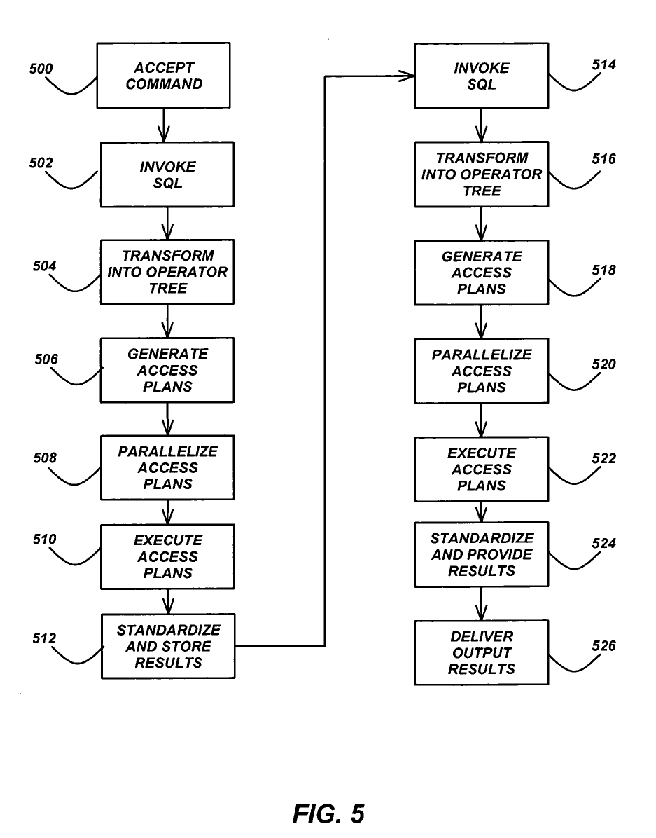

FIG. 5 is a flow chart illustrating the logic of the preferred embodiment of the present invention. Those skilled in the art will recognize that this logic is provided for illustrative purposes only and that different logic may be used to accomplish the same results.

Block 500 represents the Value Analyzer Client 102 accepting commands from a user to invoke or perform one or more Profitability Calculations 200.

Block 502 represents the Value Analyzer Calculation Engine 104 invoking one or more SQL macros in the RDBMS 106 to select accounts, products and events from the relational database based on the specified Profitability Calculations 200.

Block 504 represents the Parsing Engine 108 of the RDBMS 106 accessing the SQL macros and the SQL statements therein, and transforming the statements into an operator tree.

Block 506 represents the Parsing Engine 108 of the RDBMS 106 generating one or more access plans from the operator tree.

Block 508 represents the Parsing Engine 108 of the RDBMS 106 parallelizing the access plans, and then transmitting the access plans to their assigned Access Module Processors 110A-E of the RDBMS 106.

Block 510 represents the Access Module Processors 110A-E of the RDBMS 106 executing the access plans, and thereby performing the required data manipulation associated with the access plans received from the Parsing Engine 108, wherein the required data manipulation associated with the access plans are performed in parallel by the Access Module Processors 110A-E.

Block 512 represents the Parsing Engine 108 of the RDBMS 106 standardizing the results received from the Access Module Processors 110A-E and storing the standardized results in the intermediate tables in the relational database.

Block 514 represents the Value Analyzer Calculation Engine 104 invoking one or more SQL macros in the RDBMS 106 to perform the calculation steps of the Profitability Calculations 200 by applying the Rules 210 to the results stored in the intermediate tables in the database.

Block 516 represents the Parsing Engine 108 of the RDBMS 106 accessing the SQL macros and the SQL statements therein, and transforming the statements into an operator tree.

Block 518 represents the Parsing Engine 108 of the RDBMS 106 generating one or more access plans from the operator tree.

Block 520 represents the Parsing Engine 108 of the RDBMS 106 parallelizing the access plans, and then transmitting the access plans to their assigned Access Module Processors 110A-E of the RDBMS 106.

Block 522 represents the Access Module Processors 110A-E of the RDBMS 106 executing the access plans, and thereby performing the required data manipulation associated with the access plans received from the Parsing Engine 108, wherein the required data manipulation associated with the access plans are performed in parallel by the Access Module Processors 110A-E.

Block 524 represents the Parsing Engine 108 of the RDBMS 106 standardizing the results received from the Access Module Processors 110A-E and providing the standardized results to the Value Analyzer Calculation Engine 104.

Block 526 represents the Value Analyzer Calculation Engine 104 delivering the output or results from the Profitability Calculations 200 to the Value Analyzer Client 102 and/or the RDBMS 106. With regard to the Value Analyzer Client 102, the results may be presented to the user, printed, or used by various other computer programs, as desired. With regard to the RDBMS 106, the results may be stored for later use by the Value Analyzer Client 102, the Value Analyzer Calculation Engine 104, or other computer programs, as desired.

### CONCLUSION

This concludes the description of the preferred embodiment of the invention. The following paragraphs describe some alternative embodiments for accomplishing the same invention.

In one alternative embodiment, any type of computer or configuration of computers could be used to implement the present invention. In addition, any database management system, decision support system, on-line analytic processing system, or other computer program that performs similar functions could be used with the present invention.

In summary, the present invention discloses a Value Analyzer system, which is a data-driven computer-facilitated financial model that provides accurate and consistent profitability calculations using account, product and event attributes stored in a relational database managed by a relational database management system (RDBMS). Profitability calculations are performed in the computer by applying one or more rules to the account, product and event attributes accessed from the database, wherein at least one of the rules contains one or more formulae that is reconstructed and dynamically interpreted when the rule is being performed.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of performing financial processing in one or more computers, comprising:
(a) accessing account, product and event attributes from a database, wherein: (1) the account attributes comprise data about accounts being measured, (2) the product attributes comprise data about products being purchased, and (3) the event attributes comprise data about account-related and product-related transactions; and
(b) performing one or more profitability calculations by applying one or more rules to the account, product and event attributes accessed from the database;
(c) wherein at least one of the rules contains one or more formulae that is reconstructed and dynamically interpreted when the rule is being performed.

2. The method of claim 1, wherein the formulae is comprised of component elements that are mapped from the database.

3. The method of claim 2, wherein the component elements are comprised of operators, attributes, previous rule results, or global constants.

4. The method of claim 3, wherein the component elements are stored as types and ids.

5. The method of claim 4, wherein the type identifies a table and the id is a key into the table.

6. The method of claim 2, wherein the component elements are updated without changing the formula.

7. The method of claim 1, wherein the formula is translated into one or more text strings for SQL generation.

8. An apparatus for financial processing, comprising:
(a) a computer,
(b) logic, performed by a computer, for
(1) accessing account, product and event attributes from a database, wherein: (1) the account attributes comprise data about accounts being measured, (2) the product attributes comprise data about products being purchased, and (3) the event attributes comprise data about account-related and product-related transactions; and
(2) performing one or more profitability calculations by applying one or more rules to the account, product and event attributes accessed from the database;
(3) wherein at least one of the rules contains one or more formulae that is reconstructed and dynamically interpreted when the rule is being performed.

9. The apparatus of claim 8, wherein the formulae is comprised of component elements that are mapped from the database.

10. The apparatus of claim 9, wherein the component elements are comprised of operators, attributes, previous rule results, or global constants.

11. The apparatus of claim 10, wherein the component elements are stored as types and ids.

12. The apparatus of claim 11, wherein the type identifies a table and the id is a key into the table.

13. The apparatus of claim 9, wherein the component elements are updated without changing the formula.

14. The apparatus of claim 8, wherein the formula is translated into one or more text strings for SQL generation.

15. An article of manufacture embodying logic for performing financial processing in a computer, the logic comprising:
(a) accessing account, product and event attributes from a database, wherein: (1) the account attributes comprise data about accounts being measured, (2) the product attributes comprise data about products being purchased, and (3) the event attributes comprise data about account-related and product-related transactions; and
(b) performing one or more profitability calculations by applying one or more rules to the account, product and event attributes accessed from the database;
(c) wherein at least one of the rules contains one or more formulae that is reconstructed and dynamically interpreted when the rule is being performed.

16. The article of claim 15, wherein the formulae is comprised of component elements that are mapped from the database.

17. The article of claim 16, wherein the component elements are comprised of operators, attributes, previous rule results, or global constants.

18. The article of claim 17, wherein the component elements are stored as types and ids.

19. The article of claim 18, wherein the type identifies a table and the id is a key into the table.

20. The article of claim 16, wherein the component elements are updated without changing the formula.

21. The article of claim 15, wherein the formula is translated into one or more text strings for SQL generation.
